(19) United States
(12) Patent Application Publication
(10) Pub. No.: US 2016/0375754 A1
(43) Pub. Date: Dec. 29, 2016

(54) SELECTABLE ONE-WAY CLUTCH AND VEHICLE

(71) Applicant: TOYOTA JIDOSHA KABUSHIKI KAISHA, Toyota-shi (JP)

(72) Inventors: Yuki KUROSAKI, Susono-shi (JP); Hiroyuki SHIOIRI, Yokohama-shi (JP); Hideaki KOMADA, Gotemba-shi (JP); Hiroyuki SHIBATA, Odawara-shi (JP); Hiroki YASUI, Susono-shi (JP)

(73) Assignee: TOYOTA JIDOSHA KABUSHIKI KAISHA, Toyota-shi (JP)

(21) Appl. No.: 15/194,930

(22) Filed: Jun. 28, 2016

(30) Foreign Application Priority Data
Jun. 29, 2015 (JP) 2015-130343
Apr. 28, 2016 (JP) 2016-090900

(51) Int. Cl. B60K 6/383; F16H 37/08; B60K 6/442; F16H 3/72; F16D 41/12; B60K 6/365

(52) U.S. Cl. CPC B60K 6/383; F16D 41/125; B60K 6/365; B60K 6/442; F16H 3/728; F16H 37/0813; Y10S 903/913; Y10S 903/91; B60Y 2200/92; B60Y 2306/03; B60Y 2400/427; B60Y 2400/73

(57) ABSTRACT

A selectable one-way clutch to prevent an unintentional engagement, and a vehicle having the selectable one-way clutch are provided. The selectable one-way clutch comprises a fixed plate, a rotary plate opposed to the fixed plate, and a selector plate interposed between the fixed plate and the rotary plate. A strut is held on the fixed plate in a pivotal manner to be selectively engaged with the rotary plate. The selector plate is rotated between an engagement position at which the strut is allowed to project toward the rotary plate to be engaged therewith, and a disengagement position at which the strut is pushed into the fixed plate to be disengaged from the rotary plate. A groove inlet is formed on the inner face to introduce oil to a clearance between the fixed plate and the selector plate.

The present invention claims the benefit of Japanese Patent Applications No. 2015-130343 filed on Jun. 29, 2015 and No. 2016-090900 filed on Apr. 28, 2016 with the Japanese Patent Office, the disclosure of which is incorporated herein by reference in its entirety.

### BACKGROUND

Field of the Invention

Preferred example relates to the art of a selectable one-way clutch that transmits torque when rotated in a predetermined direction and overruns when rotated in an opposite direction, and to a vehicle having the selectable one-way clutch.

Discussion of the Related Art

JP-A-2015-77846 describes one example of the selectable one-way clutch of this kind used in a hybrid vehicle having an engine and a motor. In the conventional selectable one-way clutch, a selector plate is interposed between a fixed disc and a rotary disc while being allowed to rotate within a predetermined range. A plurality of struts are held in pockets formed on the fixed disc in such a manner to be pushed up by springs toward the rotary disc, and a same number of notches are formed on the rotatory disc. In order to selectively allow the struts to be engaged with the notches, apertures for letting through the struts are formed on the selector plate in the same number as the struts. When the selector plate is rotated to a disengagement position at which the apertures are individually displaced from the pockets of the fixed plate, the struts are individually pushed into the pockets by an edge of the aperture. By contrast, when the selector plate is rotated to an engagement position at which the apertures are individually overlapped with the pockets, the struts are allowed to be pushed up by the springs to be engaged with the notches. In this case, a leading end of each strut is brought into contact to an inner wall of each notch if the rotary plate is rotated in a direction toward the leading edges of the struts. However, the rotary disc is allowed to be rotated in the opposite direction while pushing the struts into the pockets by edges of the notches, that is, an overrunning of the rotary disc is allowed in the opposite direction.

In the hybrid vehicle taught by JP-A-2015-77846, an engine and a first motor are connected to a power distribution unit as a planetary gear unit, and an output torque of a second motor is added to a torque delivered through the power distribution unit. In addition, an overdrive unit also as a planetary gear unit is arranged coaxially with the power distribution unit. A predetermined rotary element of the overdrive unit is connected to the rotary disc of the selectable one-way clutch, and the fixed disc of the selectable one-way clutch is fixed to a casing.

Thus, the selectable one-way clutch stops a rotation of a rotary element in a predetermined direction in an engagement mode, and allows the rotary element to rotate in both directions in a disengagement mode. In order to reduce friction and resistance among the fixed disc, the selector plate and the rotary disc, lubricating oil is applied to the selectable one-way clutch.

Viscosity of the lubricating oil is increased with a reduction in a temperature thereof. In the selectable one-way clutch, if a temperature of the lubricating oil is low and hence the viscosity thereof is high, the selector plate may be rotated unwillingly by a drag torque resulting from a rotation of the rotary disc in the disengagement mode. Consequently, if the selector plate is rotated to the engagement position, the struts are pushed up into the notches to bring the selectable one-way clutch into the engagement mode thereby stopping the rotation of the rotary member unintentionally. Thus, if the viscosity of the lubricating oil is too high, the selectable one-way clutch may be brought into the engagement mode unwillingly.

If the selectable one-way clutch used in an automobile is thus brought into the engagement mode unwillingly, shocks may occur in a powertrain and components of the selectable one-way clutch may be damaged.

### SUMMARY

Aspects of preferred example has been conceived noting the foregoing technical problems, and it is therefore an object of the preferred embodiment is to provide a selectable one-way clutch configured to prevent an unintentional engagement, and a vehicle having the selectable one-way clutch thus structured.

According to one aspect of the preferred embodiment, there is provided a selectable one-way clutch, comprising: a fixed plate that is fixed in a manner not to rotate; a rotary plate that is opposed to the fixed plate while being allowed to rotate relatively to the fixed plate; a strut that is held on one face of the fixed plate facing to the rotary plate in a pivotal manner to be selectively engaged with the rotary plate to allow torque transmission between the fixed plate and the rotary plate; and a selector plate that is interposed between the fixed plate and the rotary plate, while being allowed to rotate within a predetermined range between an engagement position at which the strut is allowed to project toward the rotary plate to be engaged therewith, and a disengagement position at which the strut is pushed into the fixed plate to be disengaged from the rotary plate. In order to achieve the above-explained objective, according to one aspect of the preferred example, the fixed plate is provided with an inner face that is opposed to the selector plate, and a groove inlet that is formed on the inner face to introduce oil to a clearance between the fixed plate and the selector plate.

In a non-limiting embodiment, a plurality of the struts may be arranged on said one face of the fixed plate in a circular manner while keeping predetermined intervals, and the groove inlet may be formed between the struts.

In a non-limiting embodiment, the selector plate may be shaped into an annular plate, and the fixed plate may be provided with an inner edge having an outer diameter smaller than an inner diameter of an opening of the selector plate and protruding toward the rotary plate through the opening of the selector plate. In addition, the groove inlet may also be formed on the inner edge.

According to another aspect of the preferred embodiment, there is provided a vehicle comprising the above-explained selectable one-way clutch. In order to achieve the above-explained objective, in the vehicle according to another aspect of the preferred embodiment, the fixed plate may be an annular plate formed around a predetermined center axis that is fixed to a predetermined member of the vehicle in such a manner as to keep the center axis to a horizontal attitude. The fixed plate may comprise an inner face that is opposed to the selector plate, and a groove inlet that is formed on the inner face to introduce oil to a clearance between the fixed plate and the selector plate. In addition, the groove inlet may be situated lower than the center axis of the fixed plate.

In a non-limiting embodiment, the vehicle may further comprise an engine, and a rotary member that is rotated when starting the engine in a same direction as a rotational direction of the engine, and that is halted in a predetermined running condition of the vehicle. The rotary member may be connected to the rotary plate.

In a non-limiting embodiment, the vehicle may further comprise: an engine; a first motor having a generating function; a power distribution device adapted to perform a differential action among a first rotary element that is connected to the engine, a second rotary element that is connected to the first motor and a third rotary element that outputs torque; a second motor having a generating function that is adapted to add a torque to an output torque of the third rotary element, and to reduce the output torque of the third rotary element; and a casing holding at least the first motor, the power distribution device and the second motor. In the vehicle, the fixed plate may be connected to the casing, and the rotary plate may be connected to the second rotary element.

In the above-explained vehicle, the power distribution device may be a single-pinion planetary gear unit comprising: a first sun gear serving as the second rotary element; a first ring gear serving as the third rotary element; a first carrier serving as the first rotary element; and a first pinion gear that is interposed between the first sun gear and the first ring gear while being supported rotatably by the first carrier.

In a non-limiting embodiment, the vehicle may further comprise: an engine; a first motor having a generating function; a power distribution device adapted to perform a differential action among a first rotary element that is connected to the engine, a second rotary element that is connected to the first motor and a third rotary element that outputs torque; a second motor having a generating function that is adapted to add a torque to an output torque of the third rotary element, and to reduce the output torque of the third rotary element; a speed change device that is adapted to perform a differential action among a fourth rotary element connected to the first rotary element and to the engine, a fifth rotary element connected to the second rotary element and to the first motor, and a sixth rotary element that is selectively halted; and a casing holding at least the first motor, the power distribution device, the second motor and the speed change device. In the vehicle, the fixed plate may be connected to the casing, and the rotary plate may be connected to the sixth rotary element.

In the above-explained vehicle, the power distribution device may be a single-pinion planetary gear unit comprising: a first sun gear serving as the second rotary element; a first ring gear serving as the third rotary element; a first carrier serving as the first rotary element; and a first pinion gear that is interposed between the first sun gear and the first ring gear while being supported rotatably by the first carrier. On the other hand, the speed change device may be a double-pinion planetary gear unit comprising: a second sun gear serving as the fifth rotary element; a second ring gear serving as the sixth rotary element; a second pinion gear meshing with the second sun gear; a third pinion gear interposed between the second pinion gear and the second ring gear; and a second carrier serving as the fourth rotary element supporting the second pinion gear and the third pinion gear.

In a non-limiting embodiment, the vehicle may further comprise: an engine; a first motor having a generating function; a power distribution device adapted to perform a differential action among a first rotary element that is connected to the engine, a second rotary element that is connected to the first motor and a third rotary element that outputs torque; a second motor having a generating function that is adapted to add a torque to an output torque of the third rotary element, and to reduce the output torque of the third rotary element; and a casing holding at least the first motor, the power distribution device, and the second motor. In the vehicle, the fixed plate may be connected to the casing, and the rotary plate may be connected to the engine and to the first rotary element.

In the above-explained vehicle, the power distribution device may be a single-pinion planetary gear unit comprising: a first sun gear serving as the second rotary element; a first ring gear serving as the third rotary element; a first carrier serving as the first rotary element; and a first pinion gear that is interposed between the first sun gear and the first ring gear while being supported rotatably by the first carrier.

In the selectable one-way clutch according to the preferred embodiment, the rotary plate is rotated continuously and the selector plate is rotated within the predetermined range. In order to reduce resistance and friction between the rotary plate and the selector plate, a predetermined clearance is maintained therebetween. However, since there would be no serious problem even if the selector plate is contacted to the fixed plate, a clearance between the selector plate and the fixed plate is narrower than that between the rotary plate and the selector plate. In order to deliver lubricating oil to such narrow clearance between the selector plate and the fixed plate, the fixed plate is provided with the groove inlet. According to the preferred embodiment, therefore, the lubricating oil may be delivered not only to the clearance between the selector plate and the rotary plate, but also to the clearance between the selector plate and the fixed plate. In the selectable one-way clutch thus structured, the selector plate is subjected to a drag torque through the lubricating oil interposed between the rotary plate and the selector plate when the rotary plate is rotated. Since the clearance between the selector plate and the fixed plate is narrow, such drag torque acting between the rotary plate and the selector plate is increased. In this situation, since the fixed plate is not rotated, the drag torque acts between the selector plate and the fixed plate in a direction to stop a rotation of the selector plate. For this reason, even if an oil temperature is low and hence oil viscosity is high, the drag torque acting in the direction to rotate the selector plate toward an engagement position at which the fixed plate is engaged with the rotary plate is cancelled by the drag torque acting in a counter direction through the oil introduced to the clearance between the selector plate and the fixed plate from the groove inlet. Consequently, the selector plate can be prevented from being rotated to the engagement position undesirably.

Since the inlet to introduce the oil to the clearance between the selector plate and the fixed plate is formed into a groove, ample amount of the oil can be held between the selector plate and the fixed plate. For this reason, the rotation of the selector plate toward the engagement position can be stopped certainly.

Since the fixed plate is formed into an annular plate and the groove inlet is situated lower than the center axis of the fixed plate, the oil can be delivered sufficiently to the clearance between the fixed plated and the selector plate.

In addition, since the groove inlet is formed on the inner edge of the fixed plate, the clearance between the selector plate and the fixed plate can be maintained by the inner edge so that the oil is allowed to be introduced to the clearance between the selector plate and the fixed plate.

In the vehicle to which the selectable one-way clutch according to the preferred embodiment is applied, the rotary plate is connected to the rotary element that is rotated in the rotational direction of the engine when starting the engine, and that is halted in the predetermined running condition. However, since the selector plate can be prevented from being rotated undesirably to the engagement position by the above-explained principle, the selectable one-way clutch can be prevented from being brought into engagement accidentally so that the engine can be started smoothly. In addition, shocks resulting from a fluctuation in the driving force can be reduced, and damages on elements of the selectable one-way clutch can be limited.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a partial perspective view showing the selectable one-way clutch according to the preferred embodiment;

FIG. 2 is an exploded view of the selectable one-way clutch according to the preferred embodiment;

FIG. 3a is a partial cross-sectional view showing the selectable one-way clutch in engagement;

FIG. 3b is a partial cross-sectional view showing the selectable one-way clutch in disengagement;

FIG. 4 is a cross-sectional view of the selectable one-way clutch along IV-IV line shown in FIG. 1;

FIG. 5a is an enlarged cross-sectional view of the selectable one-way clutch along A-A line shown in FIG. 1;

FIG. 5b is a partial cross-sectional view of the selectable one-way clutch along B-B line shown in FIG. 1;

FIG. 6 is a schematic illustration showing one example of a powertrain of the hybrid vehicle to which the selectable one-way clutch according to the preferred embodiment is applied;

FIGS. 7a, 7b and 7c are nomographic diagrams showing rotational speeds of rotary elements of the power distribution device shown in FIG. 6;

FIG. 8 is a schematic illustration showing another example of a powertrain of the hybrid vehicle to which the selectable one-way clutch according to the preferred embodiment is applied;

FIGS. 9a, 9b and 9c are nomographic diagrams showing rotational speeds of rotary elements of the overdrive device shown in FIG. 8;

FIG. 10 is a partial cross-sectional view showing the overdrive device and the selectable one-way clutch shown in FIG. 8;

FIG. 11 is partial cross-sectional view of the inlet; and

FIG. 12 is a schematic illustration showing still another example of a powertrain of the hybrid vehicle to which the selectable one-way clutch according to the preferred embodiment is applied.

### DETAILED DESCRIPTION OF THE PREFERRED EMBODIMENT(S)

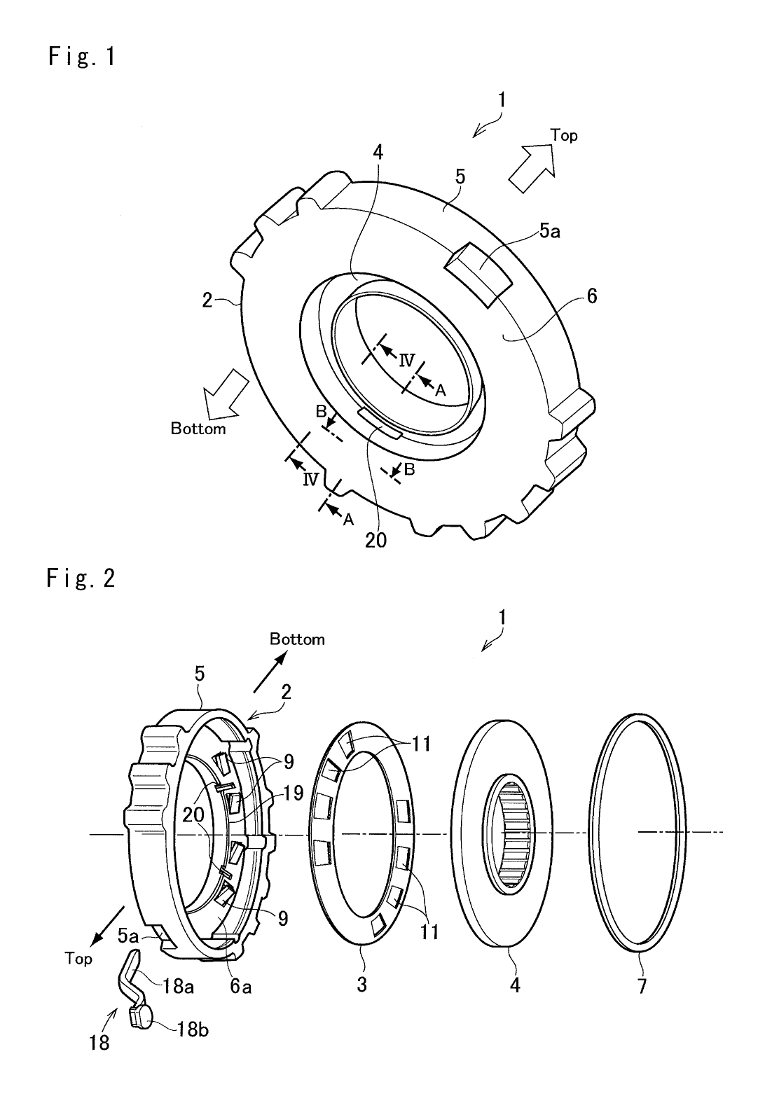

Preferred embodiments of the present application will now be explained with reference to the accompanying drawings. First of all, a fundamental structure of the selectable one-way clutch (to be abbreviated as the “SOWC” hereinafter) 1 will be explained with reference to the perspective view shown in FIG. 1 and the exploded view shown in FIG. 2. As shown in FIG. 2, the SOWC 1 comprises a pocket plate 2 as a fixed plate, a selector plate 3, and a notch plate 4 as a rotary plate. The pocket plate 2 comprises an outer cylinder 5 and an annular plate 6 formed along an inner circumference of the cylinder 5. The selector plate 3 and the notch plate 4 are held in the cylinder 5 in the order shown in FIG. 2, and a snap ring 7 is fitted into a clearance between an outer circumference of the notch plate 4 and an inner circumference of the cylinder 5 of the pocket plate 2 to close the pocket plate 2.

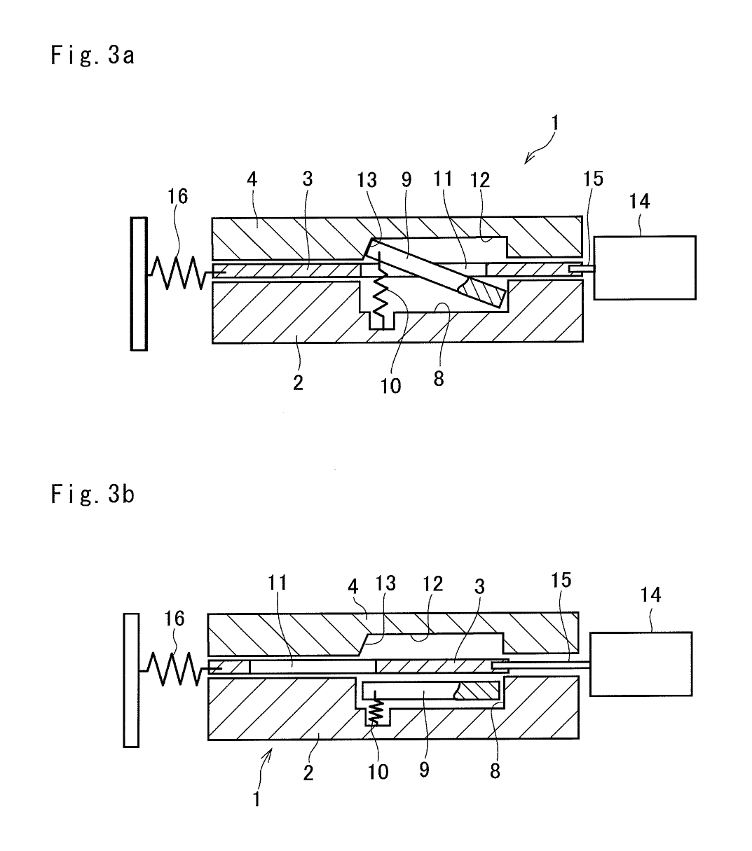

Turning to FIGS. 3a and 3b, there is partially shown a cross-section of the SOWC 1 thus assembled. As illustrated in FIGS. 3a and 3b, a plurality of pockets (or depressions) 8 are formed in a circular manner on an inner face 6a of the annular plate 6 of the pocket plate 2 being opposed to the notch plate 4, and a rectangular strut 9 is individually held in each pocket 8 in a pivotal manner around one end thereof as a fulcrum. In order to push up the other end (i.e., a leading end) of the strut 9 toward the notch plate 4, a spring 10 is interposed between the leading end of the strut 9 and a bottom of the pocket 8.

The selector plate 3 is an annular member having similar dimensions as the annular plate 6 of the pocket plate 2, and apertures 11 are formed on the selector plate 3 in a circular manner and in a same number as the pockets 8. As shown in FIG. 3a, when the selector plate 3 is rotated in the pocket plate 2 to an engagement position at which the apertures 11 are individually overlapped with each of the pockets 8, the leading end of each strut 9 is allowed to be pushed up by the spring 10 to be engaged with an after-mentioned notch 12 of the notch plate 4. By contrast, when the selector plate 3 is rotated to a disengagement position at which the apertures 11 are individually displaced from each of the pockets 8, each strut 9 is pushed into the pocket 8 by the selector plate 3 as shown in FIG. 3b.

The notch plate 4 is also an annular member, and the notches 12 are formed on a face of the notch plate 4 facing to the pocket plate 2 in a circular manner and in the same number as the pockets 8. When the leading end of the strut 9 is pushed into the notch 12 through the aperture 11, the leading end of the strut 8 is brought into abutment to an engagement wall 13.

In order to rotate the selector plate 3 between the engagement position shown in FIG. 3a and the disengagement position shown in FIG. 3b, the SOWC 1 is provided with an actuator 14 as a solenoid actuator. The actuator 14 comprises a plunger 15 connected to the selector plate 3. The plunger 15 is constantly pushed by a coil spring 16, and pulled by an electromagnetic force toward the actuator 14 when the actuator 14 is energized.

Here, it is to be noted that FIGS. 3a and 3b are merely schematic illustrations for explaining a principle of rotating the selector plate 3 by the actuator 14, therefore, an actual structure connecting the actuator 14 to the selector plate 3 is different from that shown in FIGS. 3a and 3b. Specifically, the coil spring 16 is fitted onto the plunger 15 between a snap ring and a solenoid (neither of which are shown) while being compressed to push the plunger 15 out of the actuator 14. Turning back to FIG. 2, the selector plate 3 and the actuator 13 are connected through an arm 18. Specifically, as illustrated in FIG. 2, the arm 18 is a cranked rod member. One end 18a of the arm 18 is inserted into a through hole 5a formed on the cylinder 5 of the pocket plate 2 from outside to be connected to the selector plate 3 in such a manner as to be rotated integrally therewith. An intermediate portion of the arm 18 is bent to extend parallel to the cylinder 5 of the pocket plate 2, and the other end 18b of the arm 18 is bent radially outwardly at a point further than the cylinder 5 of the pocket plate 2. In addition, a semi-circular piece is attached to the other end 18b of the arm 18 that is connected to an intermediate portion of the plunger 15. Accordingly, the arm 18 is swung by a reciprocating motion of the plunger 15 within an opening width of the through hole 5a to rotate the selector plate 3 between the engagement position and the disengagement position.

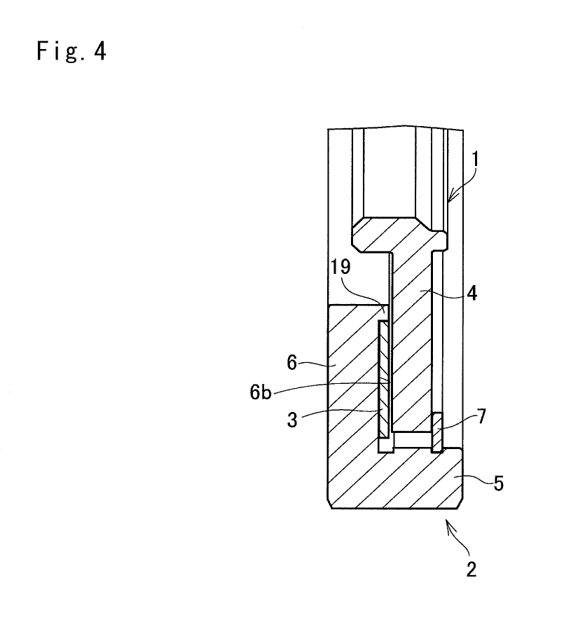

Turning to FIG. 4, there is shown a cross-sectional view of the SOWC 1 long IV-IV line shown in FIG. 1. As illustrated in FIG. 4, an annular inner edge 19 is formed along an inner circumferential edge of the annular plate 6 of the pocket plate 2 in such a manner as to protrude slightly toward the notch plate 4. Specifically, an outer diameter of the inner edge 19 is slightly smaller than an inner diameter of the selector plate 3, and a protruding length of the inner edge 19 is slightly longer than a thickness of the selector plate 3. That is, as illustrated in FIG. 4, a shallow depression 6b is formed on a radially outer portion of a face of the annular plate 6 facing to the notch plate 4, and the selector plate 3 is held in the depression 6b in a rotatable manner.

The notch plate 4 is fitted into the cylinder 5 of the pocket plate 2 after fitting the selector plate 3 into the depression 6b of the pocket plate 2, and retained by the snap ring 7 fitted into the clearance between the outer circumference of the notch plate 4 and an inner circumference of the cylinder 5 of the pocket plate 2. In the SOWC 1 thus assembled, a leading end of the inner edge 19 is adjacent to the notch plate 4 while keeping a slight clearance therebetween. That is, an axial position of the notch plate 4 is fixed by the leading end of the inner edge 19 and the snap ring 7 in such a manner as to maintain a predetermined clearance between the selector plate 3 and the notch plate 4. By contrast, since the pocket plate 2 and the selector plate 3 will not be rotated relatively to each other continuously in the same direction, the selector plate 3 is almost brought into contact to the annular plate 6 of the pocket plate 2.

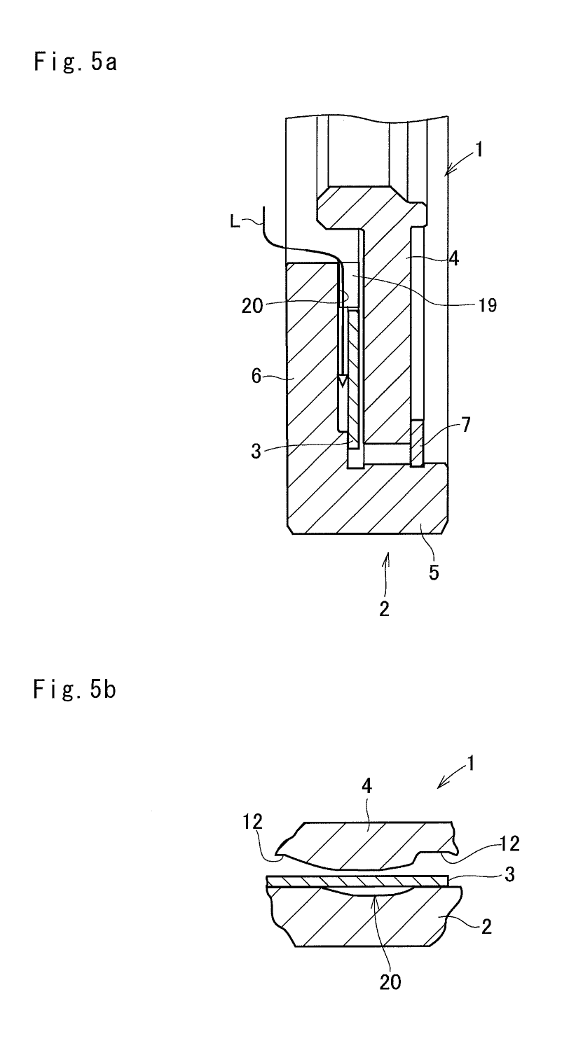

In order to introduce the lubricating oil to the clearance between the selector plate 3 and the pocket plate 2, a groove inlet 20 is formed on the inner face 6a of the annular plate 6 of the pocket plate 2 between the pockets 8 at a portion to be situated lower than the rotational center axis of the SOWC 1 kept to a horizontal attitude in the powertrain. Specifically, as depicted in FIGS. 5a and 5b, the groove inlet 20 extends radially on the inner face 6a of the annular plate 6 between a radially inner side of the cylinder 5 and the inner edge 19. That is, the clearance between the pocket plate 2 and the selector plate 3 in the axial direction is increased by the groove inlet 20 to be wider than the remaining portion in the circumferential direction. Here, it is to be noted that configurations and dimensions of the groove inlet 20 may be altered arbitrarily in according to a required amount of the lubricating oil to the clearance the pocket plate 2 and the selector plate 3. For example, the groove inlet 20 may be formed into an annular groove on the inner face 6a of the annular plate 6.

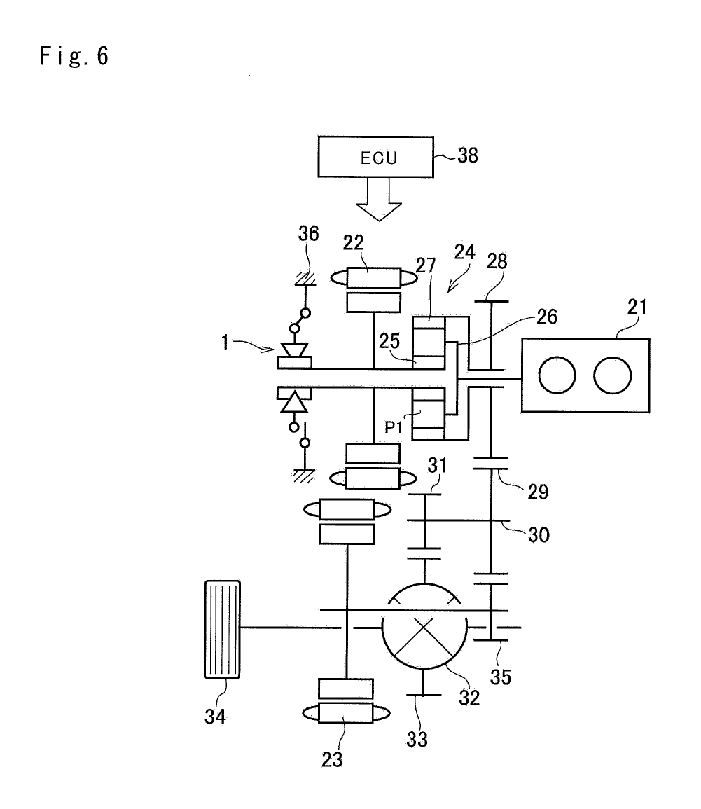

The SOWC 1 thus far explained may be used in a hybrid vehicle. Turning now to FIG. 6, there is shown an example of a powertrain of a multiple shaft type two-motor hybrid vehicle to which the SOWC 1 is applied. As shown in FIG. 6, the hybrid vehicle is provided with an engine (referred to as “ENG” in the nomographic diagrams) 21, a first motor 22 (referred to as “MG1” in the nomographic diagrams) and a second motor 23 (referred to as “MG2” in the nomographic diagrams), and both of the first motor 22 and the second motor 23 may also serve as generators. The first motor 22 is mainly used to control a speed of the engine 21 and to carry out a cranking of the engine 21. To this end, the first motor 22 is connected to the engine 21 through a power distribution device 24 as a differential unit.

For example, a single-pinion planetary gear unit or a double-pinion planetary gear unit adapted to perform a differential action among three rotary elements may be used as the power distribution device 24, and in the hybrid vehicle shown in FIG. 6, a single-pinion planetary gear unit is used as the power distribution device 24. Specifically, the power distribution device 24 comprises a sun gear 25 as a second rotary element, a carrier 26 as a first rotary element, and a ring gear 27 as a third rotary element. In the power distribution device 24, a plurality of pinion gears P1 as a first pinion gear are interposed between the sun gear 25 and the ring gear 27 while being supported rotatably by the carrier 26. The sun gear 25 is connected to a rotor of the first motor 22, the carrier 26 is connected to an output shaft (i.e., a crankshaft) of the engine 21, and the ring gear 27 serves as an output element. An output gear 28 as an output member is connected to the ring gear 27 while meshing with a counter driven gear 29 fitted onto one end of a counter shaft 30. A counter drive gear 31 that is diametrically smaller than the counter driven gear 29 is fitted onto the other end of the counter shaft 30 while meshing with a ring gear 33 of a differential unit 32. A drive torque delivered to the differential unit 32 is distributed to each drive wheel 34.

The second motor 23 is mainly used as a motor to propel the vehicle. To this end, a drive gear 35 fitted onto a rotor shaft thereof is meshed with the counter driven gear 29. The drive gear 35 is diametrically smaller than the counter driven gear 29 so that the drive gear 35 serves as a speed reducing device together with the counter driven gear 29. That is, the second motor 23 is adapted to add a torque to an output torque of the ring gear 27, and to reduce the output torque of the ring gear 27.

The SOWC 1 is disposed between the sun gear 25 connected to the first motor 22 and a casing 36 as a stationary member. Specifically, the sun gear 25 or a sun gear shaft integral therewith is connected to the notch plate 4. Accordingly, the sun gear 25 or the sun gear shaft serves as the claimed rotary member. In a disengagement mode, the SOWC 1 is allows the sun gear 25 or the sun gear shaft to rotate in both directions without transmitting torque. By contrast, in an engagement mode, the SOWC 1 inhibits the sun gear 25 or the sun gear shaft to rotate in the forward direction (i.e., in a rotational direction of the engine 21) but allows to rotate in an opposite direction (i.e., in a counter direction) without transmitting torque.

The first motor 22 and the second motor 23 are individually connected to a battery and a control device such as an inverter (both not shown) to transfer electric power therebetween. In order to control the battery, the inverter, the SOWC 1 and so on, the hybrid vehicle is provided with an electronic control unit (abbreviated as the “ECU” hereinafter) 38 as a controller composed mainly of a microcomputer. For example, detection signals of a vehicle speed, an opening degree of an accelerator, a speed and an output torque of the engine 21, torques of the motors 22 and 23, an operating mode of the SOWC 1 and so on are sent to the ECU 38. The ECU 38 carries out a calculation based on the incident data, and transmits a calculation result to the engine 21, the motors 22 and 23, the SOWC 1 and so on in the form of command signal.

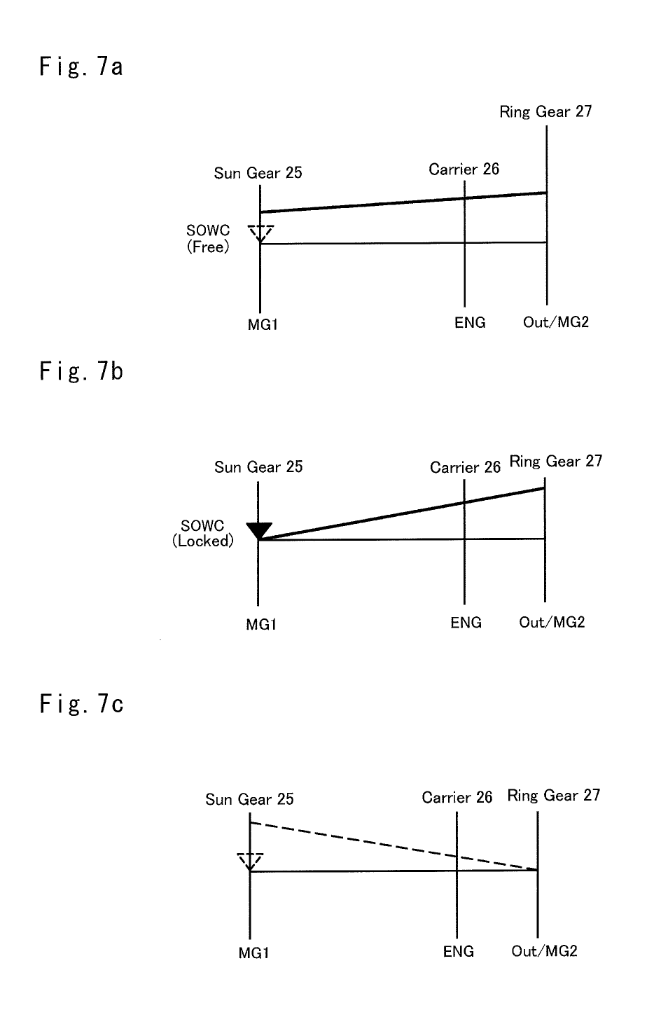

Turning to FIGS. 7a, 7b and 7c, there are shown nomographic diagrams of the power distribution device 24. Specifically, FIG. 7a shows a situation during forward propulsion of the vehicle in the hybrid mode (also called as the “HV mode” and the “power split mode”). In this situation, the engine 21 is driven and both of the carrier 26 and the ring gear 27 are rotated in the forward direction. The SOWC 1 is in the disengagement mode so that the sun gear 25 and the first motor 22 connected thereto are allowed to rotate in both directions. In the situation shown in FIG. 7a, specifically, the first motor 22 is rotated in the forward direction to serve as a generator. That is, the first motor 22 establishes a negative torque (downwardly in FIG. 7a) to control the rotational speed of the engine 21 in an optimally fuel efficient manner. An electric power generated by the first motor 22 is supplied to the second motor 23 so that the second motor 3 generates a driving force to propel the vehicle.

FIG. 7b shows a situation during forward propulsion of the vehicle in the parallel mode in which the vehicle is powered by the engine 21 or by the engine 21 and the second motor 23 while restricting a forward rotation of the sun gear 25 by the SOWC 1. In this situation, the ring gear 27 is rotated at a speed higher than the rotational speed of the engine 21 (or the carrier 26) to deliver torque to the drive wheels 34 through the differential unit 32, and an output torque of the second motor 23 can be added to the torque delivered to the drive wheels 34. In this case, the first motor 22 is halted together with the sun gear 25 while stopping a power supply thereto so that the fuel efficiency at high speed range can be improved.

FIG. 7c shows a situation during starting the engine 21 in the stopping vehicle. When the hybrid vehicle is stopped, the sun gear 25, the carrier 26 and the ring gear 27 are not rotated, and if a brake or a parking lock is applied, the ring gear 27 is halted. In this situation, if the sun gear 25 is rotated in the forward direction by the first motor 22, the torque rotating the carrier 26 in the forward direction is applied to the crankshaft of the engine 1. In FIG. 7c, a situation during execution of a cranking of the engine 21 is indicated by a dashed line.

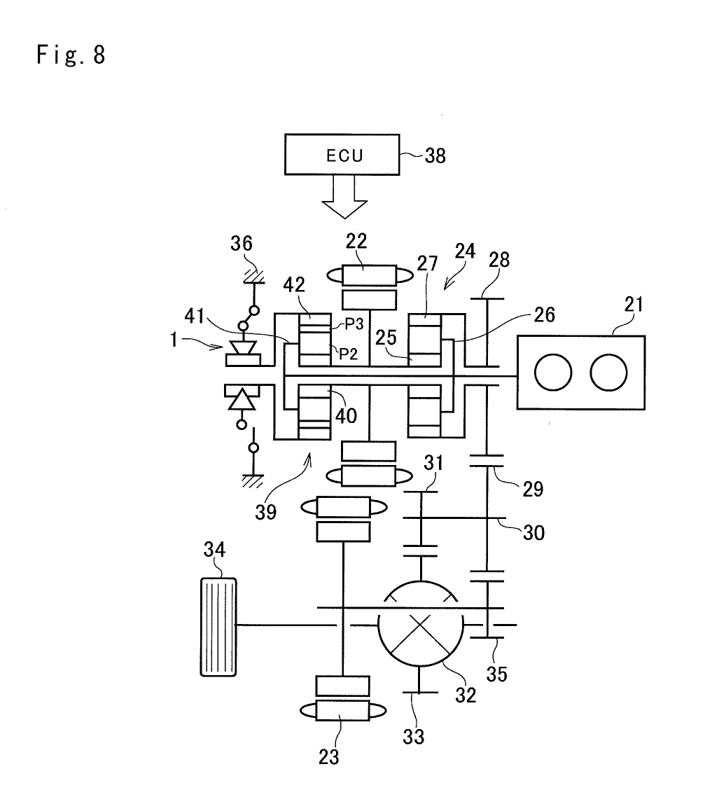

Turning to FIG. 8, there is shown another example of the hybrid vehicle to which the SOWC 1 is applied. According to the example shown in FIG. 8, the hybrid vehicle is further provided with an overdrive device (O/D) 39 as a speed change device, and the overdrive device 39 is selectively halted by the SOWC 1. Specifically, the overdrive device 39 is a double-pinion planetary gear unit having a sun gear 40 as a fifth rotary element, a carrier 41 as a fourth rotary element, and a ring gear 42 as a sixth rotary element. In the overdrive device 39, a plurality of pinion gears P2 as a second pinion gear are meshed with the sun gear 40, and a plurality of another pinion gears P3 as a third pinion gear are interposed between the pinion gears P2 and the ring gear 42. Both of the pinion gears P2 and P3 are supported rotatably by the carrier 41. The carrier 41 is connected to the carrier 26 of the power distribution device 24 so that the output torque of the engine 21 is applied to the carrier 26 and the carrier 41. The sun gear 40 of the overdrive device 39 is connected to the sun gear 25 of the power distribution device 24 so that the output torque of the first motor 22 is delivered to the sun gear 25 and the sun gear 40. The SOWC 1 is interposed between the ring gear 42 and the casing 36 to restrict a forward rotation of the ring gear 42 thereby establishing the overdrive mode. In this example, the ring gear 42 is connected to the notch plate 4 to serve as the rotary member. The remaining structures are similar to those of the hybrid vehicle shown in FIG. 6, and detailed explanations for the common elements will be omitted by allotting common reference numerals thereto. In this example, another kind of gear unit may also be used as the speed change device instead of the planetary gear unit.

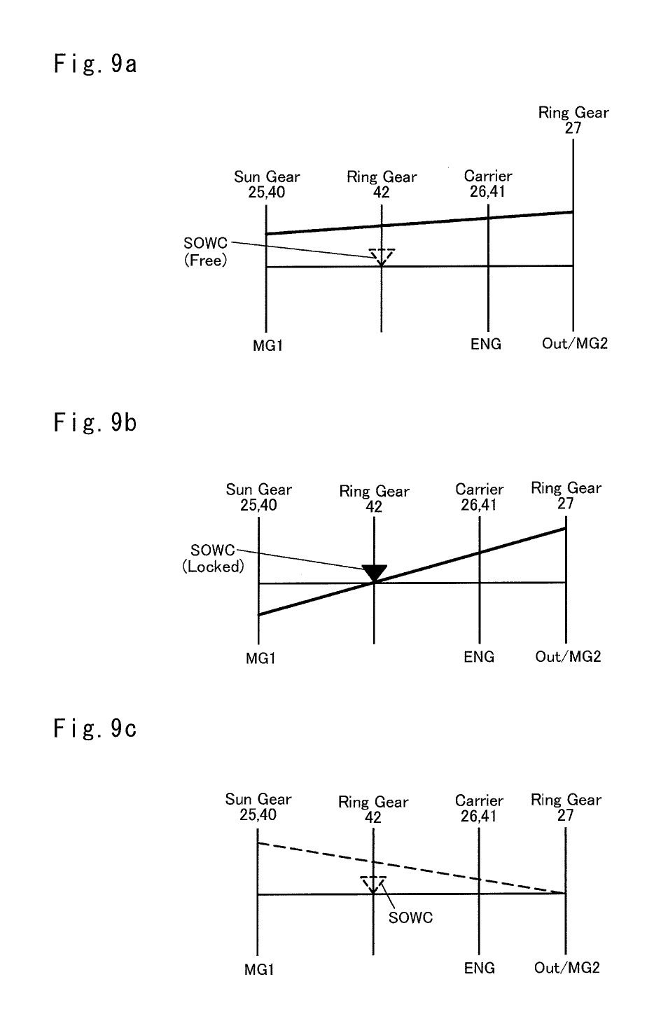

Turning to FIGS. 9a, 9b and 9c, there are shown nomographic diagrams of a combined planetary gear unit formed by the power distribution device 24 and the overdrive device 39. Specifically, FIG. 9a shows a situation during forward propulsion of the vehicle in the hybrid mode (i.e., the “HV mode” or the “power split mode”). In this situation, the engine 21 is driven and both of the carrier 26 and the ring gear 27 are rotated in the forward direction. The SOWC 17 is in the disengagement mode so that the sun gear 25 or the ring gear 42 and the first motor 22 connected thereto are allowed to rotate in both directions. In the situation shown in FIG. 9a, specifically, the first motor 22 is also rotated in the forward direction to serve as a generator. That is, the first motor 22 establishes a negative torque (downwardly in FIG. 9a) to control the rotational speed of the engine 1 in an optimally fuel efficient manner. An electric power generated by the first motor 22 is supplied to the second motor 23 so that the second motor 23 generates a driving force to propel the vehicle.

FIG. 9b shows a situation during propulsion of the vehicle in the forward direction by the engine 21 or by the engine 21 and the second motor 23 while restricting a forward rotation of the ring gear 42 by the SOWC 1. In this situation, in the overdrive device 39, a torque is applied to the carrier 41 in the forward direction while restricting the forward rotation of the ring gear 42 and hence the sun gear 40 is rotated in the counter direction. Meanwhile, in the power distribution device 24, the sun gear 25 is also rotated in the counter direction together with the sun gear 40 of the overdrive device 39. In this situation, since the output torque of the engine 21 is applied to the carrier 26 of the power distribution device 24 while rotating the sun gear 25 in the counter direction, the ring gear 27 as the output element is rotated at a speed higher than the rotational speed of the carrier 26 (or the engine 21) to establish the overdrive mode. The output torque of the second motor 23 may also be added to the torque delivered to the drive wheels 34 through the differential unit 32. In the overdrive mode, since the first motor 22 is halted together with the ring gear 42 while stopping a power supply thereto, the fuel efficiency at a high speed range may also be improved.

FIG. 9c shows a situation during starting the engine 21 in the stopping vehicle. When the hybrid vehicle is stopped, the sun gears 25 and 40, the carriers 26 and 41, and the ring gears 27 and 42 are not rotated, and the ring gear 27 is halted by the brake or parking lock. In this situation, if the sun gears 25 and 40 are rotated in the forward direction by the first motor 22, the torque rotating the carriers 26 and 41 in the forward direction is applied to the crankshaft of the engine 21 through the carrier 26, and the ring gear 42 is also rotated in the forward direction. In FIG. 9c, such situation during execution of the cranking of the engine 21 is also indicated by a dashed line.

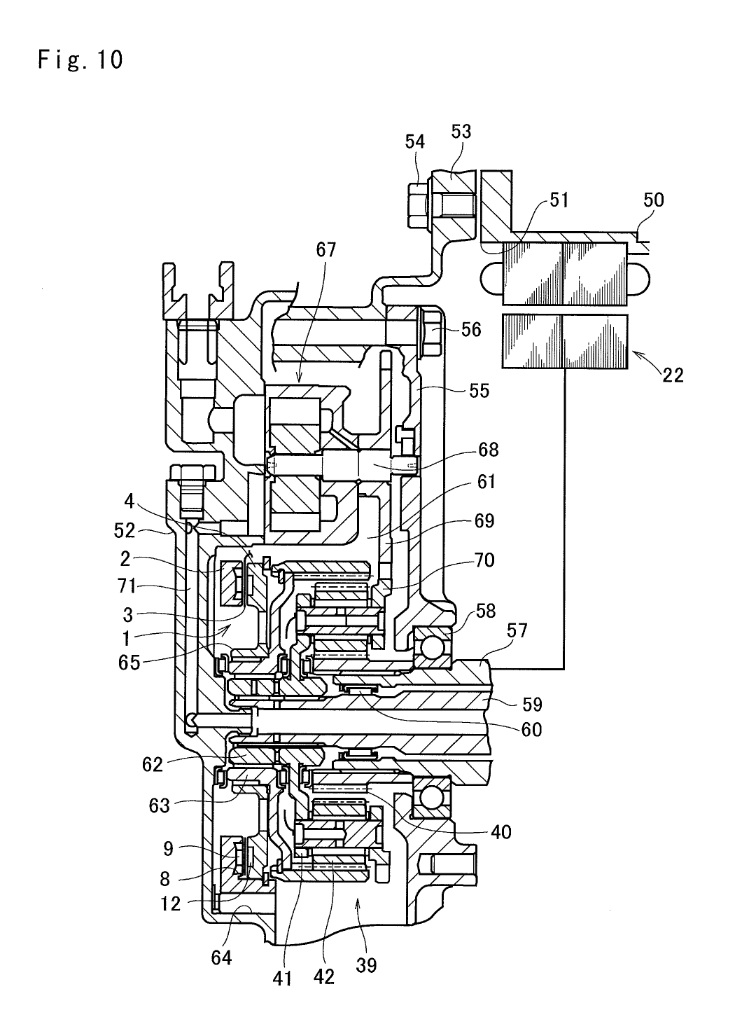

As described, in the SOWC 1, the notch plate 4 is rotated relatively to the pocket plate 2 and the selector plate 3, and the strut 9 pivots in the pocket 8. In order to allow those elements to move smoothly, the lubricating oil is supplied to the SOWC 1. Turning now to FIG. 10, there is shown a partial cross-sectional view of the powertrain shown in FIG. 8 showing a lubricating system of the SOWC 1.

As illustrated in FIG. 10, the power distribution device 24 and the first motor 22 are held in a casing 50. An opening 51 of the casing 50 is closed by an end cover 52 having a flange 53 on its outer circumferential end, and the end cover 52 is fixed to the casing 50 by a bolt 54 penetrating through the flange 53.

A portion of the end cover 52 in a slightly inner circumferential side of the flange 53 is protruded away from the casing 50 to create a recess inside of the protruded portion, and a center support 55 as a plate member is attached to an opening end of the recess by a bolt 56. A rotor shaft 57 integrated with the rotor of the first motor 22 penetrates through the center support 55 while being supported by a bearing 58 interposed therebetween. The rotor shaft 57 is a hollow shaft, and an input shaft 59 integrated with the output shaft of the engine 21 is inserted into the rotor shaft 57. In addition, a bearing 60 is interposed between an outer circumferential face of the input shaft 59 and an inner circumferential face of the rotor shaft 57 to enable a relative rotation therebetween. An end portion of the input shaft 59 protrudes from the rotor shaft 57 to the vicinity of an inner face of the end cover 52. Thus, the center support 55 closes an internal space of the end cover 52 to form a chamber 61.

The overdrive device 39 and the SOWC 1 are held in the chamber 61 thus formed. Specifically, the sun gear 40 is splined onto a leading end of the rotor shaft 57 inserted into the chamber 51. The carrier 41 has a boss 62 splined onto the input shaft 59 protruding from the rotor shaft 57, that is, the carrier 41 is connected to the engine 21. The ring gear 42 is connected to a radially outer end of a flange of a boss 63 fitted onto the boss 62 of the carrier 41 while being allowed to rotate relatively therewith. In order to selectively stop rotation of the ring gear 42 in a predetermined direction (i.e., in the forward direction), the notch plate 4 of the SOWC 1 is connected to the boss 63 connected to the ring gear 42.

A cylindrical chamber 64 is formed inside of the end cover 52 around the input shaft 59, and the SOWC 1 is held in the cylindrical chamber 64. As described, the SOWC 1 is comprised of the pocket plate 2, the notch plate 4 and the selector plate 3, and an outer diameter of the SOWC 1 is substantially identical to that of the overdrive device 39. In the powertrain shown in FIG. 10, the notch plate 4 is situated adjacent to the overdrive device 39, and the pocket plate 2 is situated adjacent to the inner wall of the end cover 52. However, the axial positions of the pocket plate 2 and the notch plate 4 may be switched according to need. The outer cylinder 5 of the pocket plate 2 is splined to an inner circumferential face of the cylindrical chamber 64 to be fixed to the end cover 52. That is, the end cover 52 serves as the casing 36 shown in FIGS. 6 and 8. A boss 65 integrally formed in an inner circumferential side of the notch plate 4 is splined onto the boss 63 connected to the ring gear 42 so that the notch plate 4 is connected with the ring gear 42.

In order to deliver lubricating oil and to generate hydraulic pressure, an oil pump 67 is also disposed in the chamber 61 in parallel with the overdrive device 39 and the SOWC 1. For example, a gear pump, a vane pump, a radial piston pump etc. adapted to generate hydraulic pressure by a rotation of a rotor or a gear may be used as the oil pump 67, and a gear 69 is fitted onto a rotary shaft 68 of the oil pump 67. The gear 69 is meshed with a gear 70 attached to the carrier 41 of the overdrive device 39 so as to drive the oil pump 67 by a power of the engine 21. In addition, a suction port, a discharging port, and an oil passage connected to those ports are formed in the end cover 52. Specifically, a discharging passage 71 extends from the oil pump 67 to a leading end of the input shaft 59 while penetrating through the end cover 52. The input shaft 59 is also a hollow shaft in which an oil passage is formed along a rotational center axis thereof, and the leading end of the input shaft 59 is engaged with a protrusion of the end cover 52 thereby connecting the oil passage formed therein to the discharging passage 71.

In the SOWC 1, the groove inlet 20 is situated lower than the rotational center axis of the SOWC 1 in the gravitational direction. The lubricating oil discharged from the oil pump 67 flows through the discharging passage 71 and the input shaft 59, and further flows radially outwardly from a radial passage formed in the input shaft 59 toward the overdrive device 39 and the SOWC 1 through a clearances and bearings. If the input shaft 59 is not rotated, the lubricating oil is not subjected to a centrifugal force so that the lubricating oil flows downwardly by a gravitational force. In this situation, as indicated by the arrow in FIG. 5a, the lubricating oil delivered to the SOWC 1 flows partially into the clearance between the pocket plate 2 and the selector plate 3 from the groove inlet 20. As described, the clearance between the selector plate 3 and the notch plate 4 is maintained widely so that the lubricating oil also flows into the clearance between the selector plate 3 and the notch plate 4. As also described, viscosity of the lubricating oil is increased with a reduction in a temperature thereof, and drag torques acting between the notch plate 4 and the selector plate 3 and acting between the selector plate 3 and the pocket plate 2 are increased with an increase in the viscosity of the lubricating oil. According to the preferred embodiment, however, the lubricating oil can be maintained amply in both sides of the selector plate 3, and hence the drag torques resulting from an increase in viscosity of the lubrication oil are applied to both sides of the selector plate 3 in opposite directions. For this reason, the selector plate 3 can be prevented from being rotated undesirably to the engagement position to bring the SPWC 1 into the engagement mode.

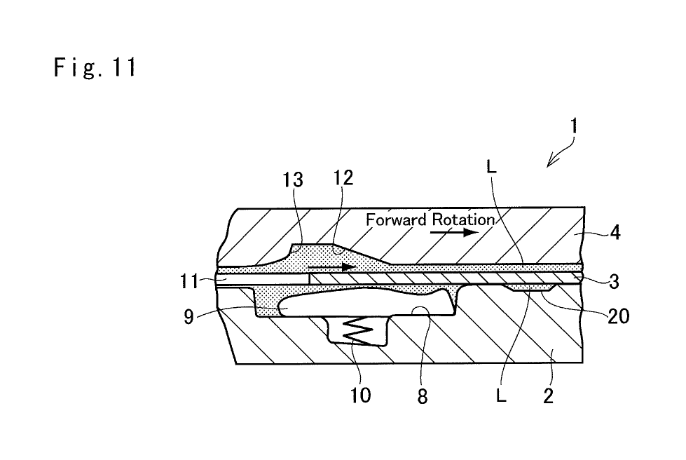

In the powertrain shown in FIG. 6 or 8, the engine 21 is rotated in the forward direction when startup, and the notch plate 4 is connected to the sun gear 25 or the ring gear 42 that is halted when propelling the vehicle in the forward direction mainly by the engine 21. When starting the engine 21, the SOWC 1 is brought into the disengagement mode to allow the sun gear 25 or the ring gear 42 to rotate in the forward direction. Specifically, as illustrated in FIG. 11, the apertures 11 of the selector plate 3 are individually displaced from each of the pockets 8 while pushing the struts 9 into the pockets 8. In this situation, when the first motor 22 is rotated in the forward direction, the notch plate 4 is rotated in the forward direction as indicated by the arrow in FIG. 11. Consequently, the selector plate 3 is subjected to a drag torque through the lubricating oil L interposed between the notch plate 4 and the selector plate 3. Such drag torque is increased with an increase in the viscosity of the lubricating oil L, the clearance between the notch plate 4 and the selector pate 3, a relative speed between the notch plate 4 and the selector pate 3 and so on. If a temperature of the lubricating oil L is too low, the viscosity of the lubricating oil L may be increased to an extent that the drag torque applied to the selector plate 3 in the forward direction toward the engagement position exceeds the elastic force of the coil spring 16 pushing the plunger 15 out of the actuator 14.

If the selector plate 3 is rotated in the forward direction, the lubricating oil L interposed between the selector plate 3 and the pocket plate 2 is subjected to a shearing force, and hence the lubricating oil L in the groove inlet 20 is introduced into the narrow clearance between the selector plate 3 and the pocket plate 2 ahead of the groove inlet 20 in the forward direction. Consequently, the drag torque also acts between the selector plate 3 and the pocket plate 2 through the lubricating oil L. In this situation, since the pocket plate 2 is fixed to the end cover 52, the drag torque acts between the selector plate 3 and the pocket plate 2 in the direction to halt a rotation of the selector plate 3 (i.e., leftward in FIG. 11). According to the preferred embodiment, the clearance between the selector plate 3 and the pocket plate 2 is very narrow, and in addition, an ample amount of the lubricating oil L is introduced thereto through the groove inlet 20. According to the preferred embodiment, therefore, the drag torque acting in the direction to stop the rotation of the selector plate 3 can be increased sufficiently. Thus, when the selector plate 3 is subjected to the drag torque resulting from rotating the notch plate in the forward direction, the drag torque is also generated between the selector plate 3 and the pocket plate 2 in the direction to stop the rotation of the selector plate 3. For this reason, the selector plate 3 is prevented from being rotated undesirably to the engagement position at which the SOWC 1 is brought into the engagement mode.

As described, in the powertrain shown in FIG. 6 or 8, the notch plate 4 is connected to the sun gear 25 or the ring gear 42 that is rotated in the forward direction when cranking the engine 21, and the forward rotation of the sun gear 25 or the ring gear 42 is stopped by engaging the SOWC 1. Specifically, a cranking (or a motoring) of the engine 21 is carried out by rotating the first motor 22 in the forward direction while disengaging the SOWC 1. In this situation, although the sun gear 25 or the ring gear 42 is rotated in the forward direction, the drag torque acting in the forward direction to rotate the selector plate 3 to the engagement position is cancelled by the drag torque acting in the counter direction. According to the preferred embodiment, therefore, the SOWC 1 can be prevented from being engaged undesirably even if the temperature of the lubricating oil is extremely low and hence the viscosity of the lubricating oil is high. For this reason, the engine 21 is allowed to be started smoothly.

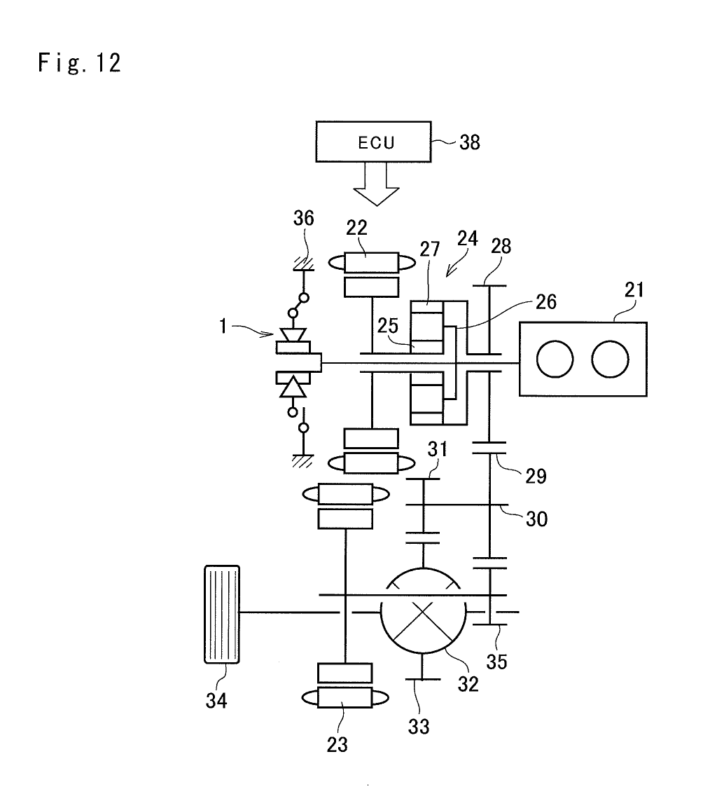

The SOWC 1 thus far explained may also be used as a brake in the powertrain shown in FIG. 12. In the powertrain shown in FIG. 12, the notch plate of the SOWC 1 is connected to the output shaft of the engine 21 or the carrier 26 to halt the forward rotation of the carrier 26, and the remaining structures are similar to those of the drive unit shown in FIG. 6. In this case, the ring gear 27 and the output gear 28 integral therewith are rotated in the counter direction to propel the vehicle in the backward direction by rotating the first motor 22 in the forward direction while halting the forward rotation of the carrier 26 by the SOWC 1. In this situation, the driving force for propelling the vehicle in the backward direction can be increased by rotating the second motor 23 in the counter direction. When starting the engine 21 in the powertrain shown in FIG. 12, the carrier 26 is rotated together with the output shaft of the engine 21 in the forward direction by the first motor 22 while disengaging the SOWC 1. In this situation, since the SOWC 1 can be prevented from being engaged undesirably by the drag torque, startup of the engine 21 can be carried out smoothly.

Although the above exemplary embodiments of the present application have been described, it will be understood by those skilled in the art that the present application should not be limited to the described exemplary embodiments, and various changes and modifications can be made within the spirit and scope of the present application.

What is claimed is:

1. A selectable one-way clutch, comprising:
a fixed plate that is fixed in a manner not to rotate;
a rotary plate that is opposed to the fixed plate while being allowed to rotate relatively to the fixed plate;
a strut that is held on one face of the fixed plate facing to the rotary plate in a pivotal manner to be selectively engaged with the rotary plate to allow torque transmission between the fixed plate and the rotary plate; and
a selector plate that is interposed between the fixed plate and the rotary plate, while being allowed to rotate within a predetermined range between an engagement position at which the strut is allowed to project toward the rotary plate to be engaged therewith, and a disengagement position at which the strut is pushed into the fixed plate to be disengaged from the rotary plate;
wherein the fixed plate comprises an inner face that is opposed to the selector plate, and a groove inlet that is formed on the inner face to introduce oil to a clearance between the fixed plate and the selector plate.

2. The selectable one-way clutch as claimed in claim 1,
wherein a plurality of the struts are arranged on said one face of the fixed plate in a circular manner while keeping predetermined intervals, and
wherein the groove inlet is formed between the struts.

3. The selectable one-way clutch as claimed in claim 1,
wherein the selector plate is an annular plate,
wherein the fixed plate comprises an inner edge having an outer diameter smaller than an inner diameter of an opening of the selector plate and protruding toward the rotary plate through the opening of the selector plate, and
wherein the groove inlet is also formed on the inner edge.

4. A vehicle comprising a selectable one-way clutch,
wherein the selectable one-way clutch comprises:
a fixed plate that is fixed in a manner not to rotate;
a rotary plate that is opposed to the fixed plate while being allowed to rotate relatively to the fixed plate;
a strut that is held on one face of the fixed plate facing to the rotary plate in a pivotal manner to be selectively engaged with the rotary plate to allow torque transmission between the fixed plate and the rotary plate; and
a selector plate that is interposed between the fixed plate and the rotary plate, while being allowed to rotate within a predetermined range between an engagement position at which the strut is allowed to project toward the rotary plate to be engaged therewith, and a disengagement position at which the strut is pushed into the fixed plate to be disengaged from the rotary plate,
wherein the fixed plate is an annular plate formed around a predetermined center axis that is fixed to a predetermined member of the vehicle in such a manner as to keep the center axis to a horizontal attitude,
wherein the fixed plate comprises an inner face that is opposed to the selector plate, and a groove inlet that is formed on the inner face to introduce oil to a clearance between the fixed plate and the selector plate, and
wherein the groove inlet is situated lower than the center axis of the fixed plate.

5. The vehicle as claimed in claim 4, further comprising:
an engine; and
a rotary member that is rotated when starting the engine in a same direction as a rotational direction of the engine, and that is halted in a predetermined running condition of the vehicle;
wherein the rotary member is connected to the rotary plate.

6. The vehicle as claimed in claim 4, further comprising:
an engine;
a first motor having a generating function;
a power distribution device adapted to perform a differential action among a first rotary element that is connected to the engine, a second rotary element that is connected to the first motor and a third rotary element that outputs torque;
a second motor having a generating function that is adapted to add a torque to an output torque of the third rotary element, and to reduce the output torque of the third rotary element; and
a casing holding at least the first motor, the power distribution device and the second motor;
wherein the fixed plate is connected to the casing; and
wherein the rotary plate is connected to the second rotary element.

7. The vehicle as claimed in claim 6,
wherein the power distribution device includes a single-pinion planetary gear unit comprising: a first sun gear serving as the second rotary element; a first ring gear serving as the third rotary element; a first carrier serving as the first rotary element; and a first pinion gear that is interposed between the first sun gear and the first ring gear while being supported rotatably by the first carrier.

8. The vehicle as claimed in claim 4, further comprising:
an engine;
a first motor having a generating function;
a power distribution device adapted to perform a differential action among a first rotary element that is connected to the engine, a second rotary element that is connected to the first motor and a third rotary element that outputs torque;
a second motor having a generating function that is adapted to add a torque to an output torque of the third rotary element, and to reduce the output torque of the third rotary element;
a speed change device that is adapted to perform a differential action among a fourth rotary element connected to the first rotary element and to the engine, a fifth rotary element connected to the second rotary element and to the first motor, and a sixth rotary element that is selectively halted; and
a casing holding at least the first motor, the power distribution device, the second motor and the speed change device;
wherein the fixed plate is connected to the casing; and
wherein the rotary plate is connected to the sixth rotary element.

9. The vehicle as claimed in claim 8,
wherein the power distribution device includes a single-pinion planetary gear unit comprising: a first sun gear serving as the second rotary element; a first ring gear serving as the third rotary element; a first carrier serving as the first rotary element; and a first pinion gear that is interposed between the first sun gear and the first ring gear while being supported rotatably by the first carrier; and
wherein the speed change device includes a double-pinion planetary gear unit comprising: a second sun gear serving as the fifth rotary element; a second ring gear serving as the sixth rotary element; a second pinion gear meshing with the second sun gear; a third pinion gear interposed between the second pinion gear and the second ring gear; and a second carrier serving as the fourth rotary element supporting the second pinion gear and the third pinion gear.

10. The vehicle as claimed in claim 4, further comprising:
an engine;
a first motor having a generating function;
a power distribution device adapted to perform a differential action among a first rotary element that is connected to the engine, a second rotary element that is connected to the first motor and a third rotary element that outputs torque;
a second motor having a generating function that is adapted to add a torque to an output torque of the third rotary element, and to reduce the output torque of the third rotary element; and
a casing holding at least the first motor, the power distribution device, and the second motor;
wherein the fixed plate is connected to the casing; and
wherein the rotary plate is connected to the engine and to the first rotary element.

11. The vehicle as claimed in claim 10,
wherein the power distribution device includes a single-pinion planetary gear unit comprising: a first sun gear serving as the second rotary element; a first ring gear serving as the third rotary element; a first carrier serving as the first rotary element; and a first pinion gear that is interposed between the first sun gear and the first ring gear while being supported rotatably by the first carrier.
